(19) United States
(12) Patent Application Publication
(10) Pub. No.: US 2020/0362632 A1
(43) Pub. Date: Nov. 19, 2020

(54) Simply Smart Ladder Clamp

(71) Applicant: Marc Fort, Slippery Rock, PA (US)

(72) Inventor: Marc Fort, Slippery Rock, PA (US)

(21) Appl. No.: 16/412,945

(22) Filed: May 15, 2019

(51) Int. Cl. E06C 7/48

(52) U.S. Cl. CPC E06C 7/486

(57) ABSTRACT

A simply smart ladder clamp includes a first generally Sigma-shaped body portion having a first downwardly extending arm and a second downwardly extending arm which together subtend and define an intermediate element with an inner laterally extending flat surface and a recess adjacent the first downwardly extending arm. A clamping member captures a flat portion of the gutter between the flat portion and an inner surface of the first downwardly extending arm to mount the simply smart ladder clamp to the gutter. Preferably two simply smart ladder clamps are used, positioned inside the legs of a ladder to prevent movement of the ladder relative to the gutter.

The present invention is a continuation-in part of U.S. Ser. No. 16/163,147 filed Oct. 17, 2018.

### BACKGROUND AND SUMMARY OF THE INVENTION

The present invention is directed to the field of safety. More particularly, the present invention is directed to an elegantly simple ladder clamp that is simple, smart, and safe.

Numerous attempts have been made to produce a ladder clamp which prevents a ladder from sliding along the face of a gutter thereby putting the ladder climber at risk for life and limb. A commonly owned invention, Ladder-Supporting Gutter Clamping System, U.S. Pat. No. 9,915,095, goes a long way toward providing simplified, effective ladder clamps. However, the present invention takes an additional step at providing simple, effective ladder clamps that can be produced inexpensively without jeopardizing effectiveness resulting in a clamp that is truly, simply safe.

The present invention is a simply smart ladder clamp for gutters having a front face with a portion which has a generally vertical face with an inwardly protruding flange, said clamp comprising a) a generally Sigma-shaped body portion having a first downwardly extending arm and a second downwardly extending arm, the first and second downwardly extending arms subtending an intermediate element having an inner laterally extending flat surface and a recess adjacent the first downwardly extending arm, the first downwardly extending arm engaging an external portion of the vertical face of the gutter and the recess accommodating the inwardly protruding flange of the gutter; b) a clamping member having a first flat face for engaging the laterally extending surface of the body portion and a second orthogonal flat face for engaging an inner surface of the vertical face of the gutter opposite the first downwardly extending arm to clamp the simply smart ladder clamp to the vertical face of the gutter; c) an elongated threaded member: i) extending through and having threaded engagement with an opening in the second downwardly extending arm; and, ii) extending through and having non-threaded engagement with an opening in the clamping member; d) cap means securing a first end of the elongated threaded member to the clamping member in a manner permitting rotation; e) a manually engageable element secured to a second end of the elongated threaded member, whereby rotation of the elongated threaded member using said manually engageable element causes movement of the clamping member from a first non-clamping position to a second clamping position engaging the inner surface of the vertical surface of the gutter. The simply smart ladder clamp may have an outer portion of the subtended intermediate element being arcuate. The manually engageable element can comprise a three- or five-star knurled grip thumb screw cap.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals in which

FIG. 1 is a schematic side view of the ladder clamp of the present invention in an open position;

FIG. 2 is a is a schematic side view of the ladder clamp in the closed clamping position;

FIG. 3 is a top view of the ladder clamp of the present invention shown in the closed clamping position;

FIG. 4A is a bottom view of the body portion of the ladder clamp;

FIG. 4B is a bottom view of the clamping member of the ladder clamp;

FIG. 5 is a schematic depiction of the ladder clamp of the present invention with a ladder;

FIG. 6A is a schematic side view of a second embodiment of the ladder clamp of the present invention;

FIG. 6B is an exploded schematic side view of the second embodiment with the clamping member removed;

FIG. 6C is a schematic side view of the second embodiment partially assembled prior to insertion of the bolt assembly into the clamping member;

FIG. 7A is a schematic bottom view of the sigma shaped portion of the second embodiment;

FIG. 7B is an exploded schematic bottom view of the sigma shaped portion shown in FIG. 7A; and,

FIG. 8 is a schematic depiction of the ladder clamp of the second embodiment used in pairs with a ladder.

### DETAILED DESCRIPTION OF THE PREFERRED EMBODIMENT(S)

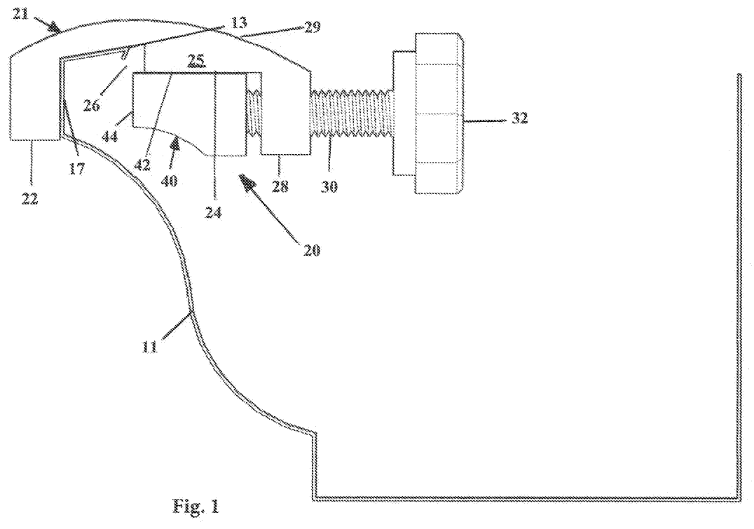

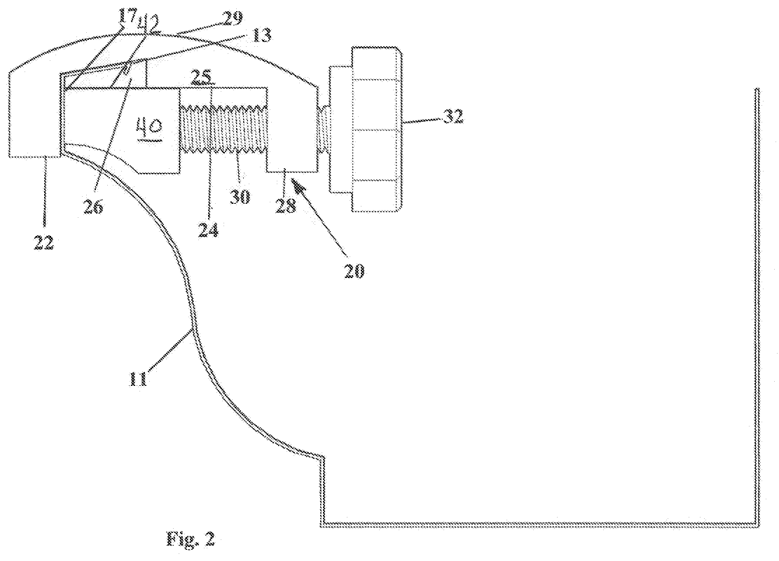

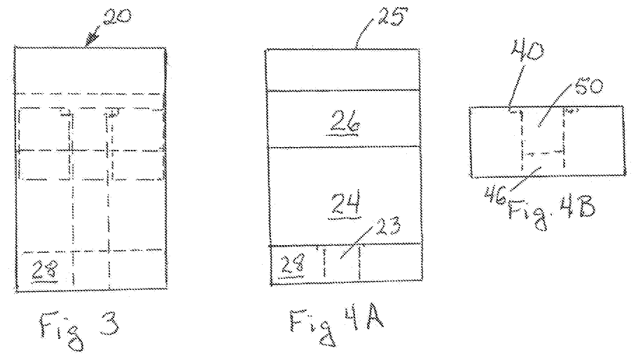

A first embodiment of the simply smart ladder clamp of the present invention is depicted in FIGS. 1-3 generally at 20. Simply smart ladder clamp 20 comprises a first generally Sigma-shaped body portion 21 having a first downwardly extending arm 22 and a second downwardly extending arm 28 which together subtend and define an intermediate element 25 with an inner laterally extending flat surface and a recess 26 adjacent the first downwardly extending arm 28. Recess 26 is formed to accommodate the inwardly protruding flange 13 of gutter 11.

A clamping member 40 has a first flat face 42 for engaging the laterally extending surface of intermediate element 25 of body portion 21 and a second orthogonal flat face 44 for engaging an inner surface of the vertical face 17 of the gutter 11 opposite first downwardly extending arm 22 to clamp said simply smart ladder clamp 20 to the vertical face 17 of the gutter 11. An elongated threaded member 30 extends through and has threaded engagement with an opening 23 in second downwardly extending arm 28 (FIG. 4A) and, extends through and has non-threaded engagement with an opening 46 in clamping member 40 (FIG. 4B). Cap 50 snaps or threads onto the end of threaded member 30 to prevent removal of clamping member 40 from threaded member 30. A recess 43 is formed in clamping member 40 so the flange 52 of cap 50 does not extend past the surface 44 of clamping member 40. The upper surface 29 of Sigma-shaped body portion 21 is preferably arcuate to more easily accommodate recess 26 without compromising the structural integrity of the ladder clamp 20. Manually engageable element 32 which preferably takes the form of a 5-armed star knurled grip thumb screw cap which is secured to the second end of threaded member 30.

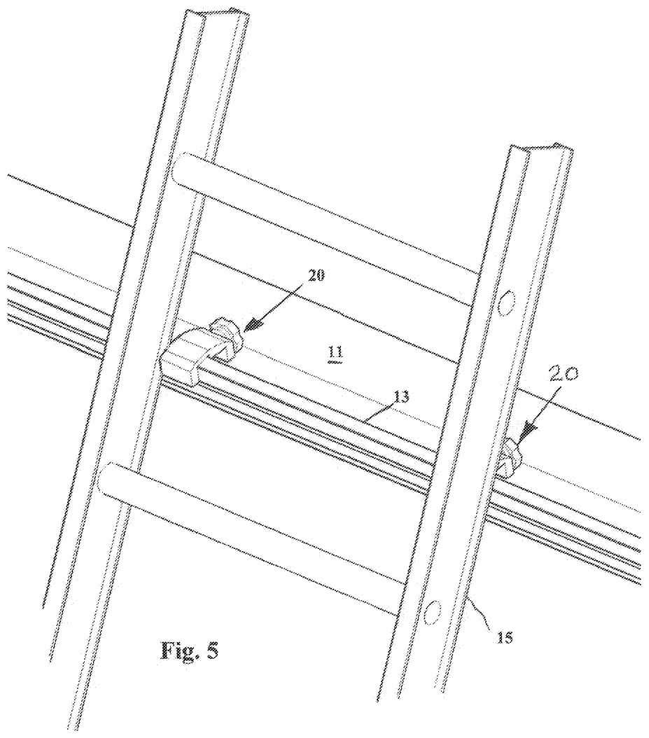

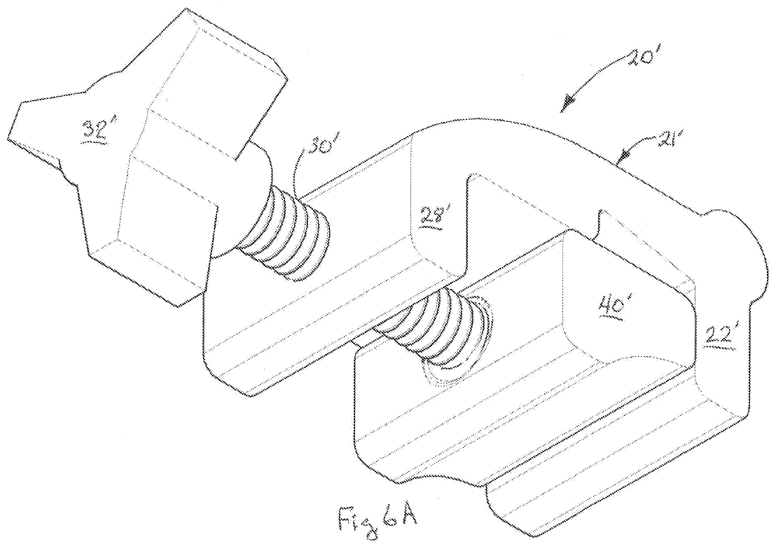

In use, simply smart ladder clamp 20, with the clamping member 40 fully retracted (FIG. 1), is placed over inwardly protruding flange 13 of gutter 11. Thumb screw cap 32 is rotated to tighten surface 44 of clamping member 40 against the inner surface of vertical face 17 capturing vertical face 17 between inner surface of extending arm 22 and surface 44. As seen in FIG. 5, it is preferred that two simply smart ladder clamps 20 be utilized, one inside each ladder legs 15 to maintain the ladder in a fixed position relative to the gutter 11. While body portion 21 and clamping member 40 of ladder clamp 20 may be made of high-strength plastic materials, it is preferred that both members be made of metallic materials such as aluminum or steel to minimize concerns about possible breakage that would give rise to safety issues.

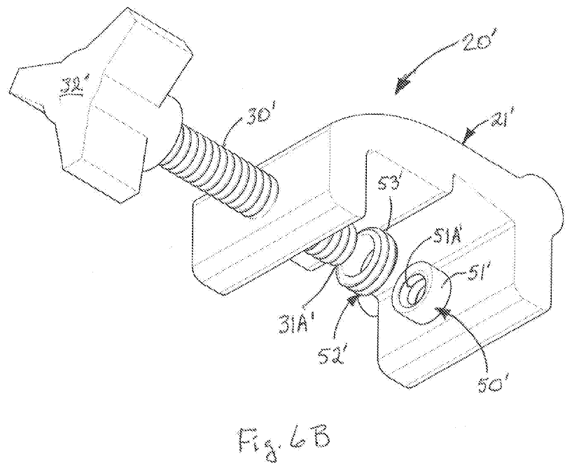

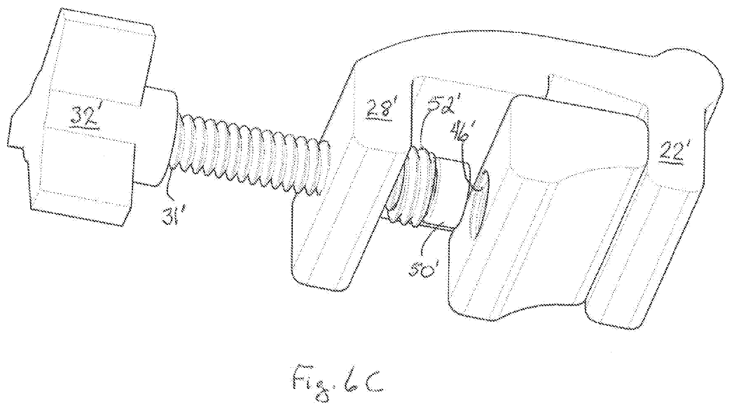

A second embodiment of the simply smart ladder clamp of the present invention is depicted in FIGS. 6A-8 generally at 20′. In this embodiment, as with the previous embodiment, ladder clamp 20′ is comprised of three main elements: sigma-shaped body portion 21′, clamping member 40′, and elongated threaded element 30′. Once again, elongated threaded element 30′ has thread engagement with second downwardly extending arm 28′ and non-threaded engagement with clamping member 40′. Two auxiliary cap rings 50′ and 52′ are employed to effect the non-threaded engagement between elongated threaded element 30′ and second downwardly extending arm 22′. Auxiliary cap rings 50′ and 52′ have a composite length generally equal to the depth of the opening 46′ in clamping member 40′. First auxiliary or cap ring 50′ has an internal thread 51A′ that mates with the external thread on first end 31A′ of elongated threaded element 30′. Cap ring 50′ is secured to the end of elongated threaded element 30′ by crimping, adhesive or, more preferably, both. As best seen in FIG. 6B, the exterior 51′ of cap ring 50′ is smooth so as to turn freely within recess 46′ in clamping member 40′ (FIG. 6C). The external thread 53′ on second cap ring 52′ mates with the internal thread 46′ in clamping member 40′. A drop of adhesive (not shown) is placed on external thread 53′ prior to inserting it into internal thread 46′ in clamping member 40′ (FIG. 6C). This cements second cap ring 52′ non-rotationally in internal thread 46′. The external diameter of first cap ring 50′ exceeds the internal diameter of second cap ring 52′ preventing removal of the protruding end of elongated threaded element 30′ from clamping member 40′. The projecting or second end 31B′ has manually engagable element 32′ which, in this case is a three-armed cap.

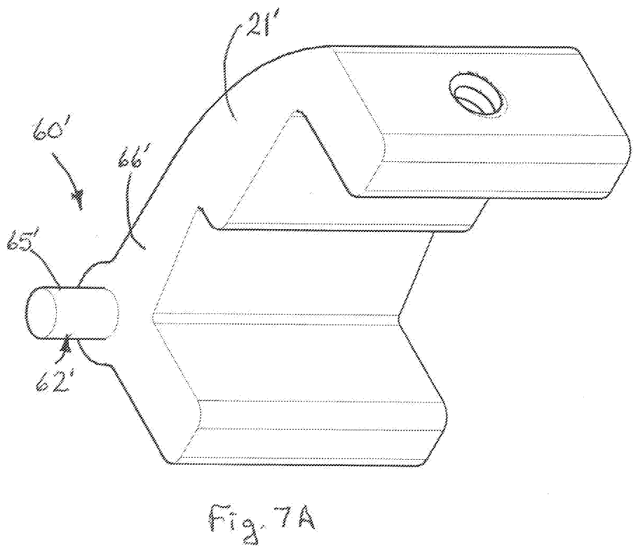

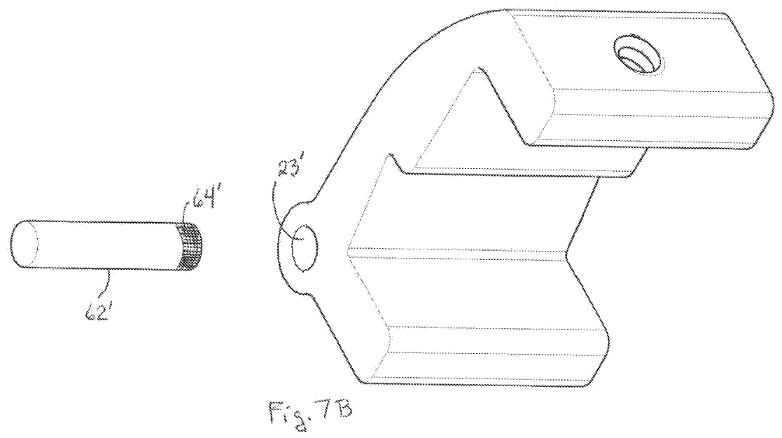

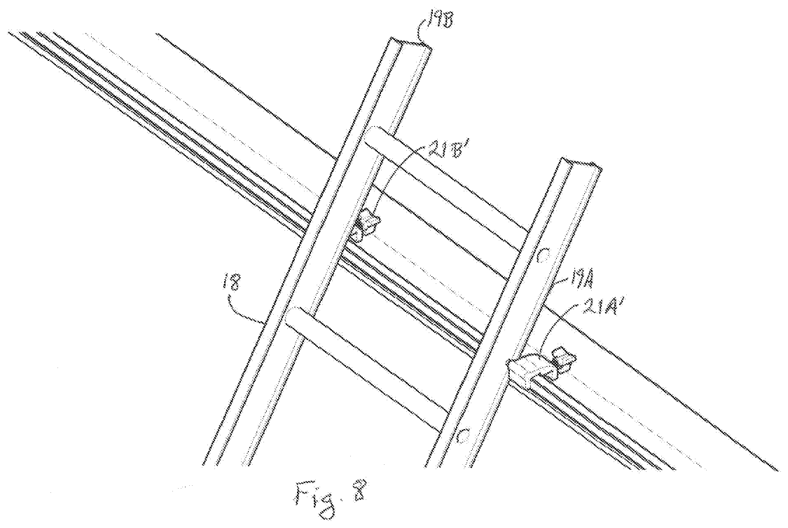

An additional feature of this second embodiment is depicted in FIGS. 7A and 7B generally at 60′. Pin 62′ has a knurled surface 64′ (FIG. 7B) formed on a first end. When the pin 62′ is pounded, knurled end first, into throughbore 23′, knurled surface 64′ will secure pin 62′ in opening 23′ with a portion 65′ protruding beyond the side 66′ of the sigma-shaped body portion 21′ (FIG. 7A). Pin 60′ can be inserted from either side creating a right ladder clamp 20A′ and a left ladder clamp 20B′ (FIG. 8). As shown in FIG. 8, these pins 60′ engage behind flanges 19A and 19B, respectively of ladder 18 to prevent the ladder being inadvertently moved outwardly from gutter 11 and possibly tilted to the right or left.

In operation, once second ring 52′ (cemented in internal thread 46′) and first cap ring 50′ (cemented and crimped onto the end of first end 31A′ of elongated threaded element 30′) are assembled in the ladder clamp assembly 20′ (FIG. 6A), since the external diameter of first cap ring 50′ is larger than internal diameter of second ring 52′, as elongated threaded element 30′ is rotated in the threaded opening 23′ to open the gap between first flat face 42′ of clamping member 40′ and first downwardly extending arm 22′, cap ring 50′ will abut the inner face of second ring 52′ pulling clamping member 40′ to an open position. As cap screw 32′ is rotated in a clockwise direction, the leading end of cap ring 50′ will engage the end of internal opening 46′ pushing against the inner bore and moving clamping member 40′ to a closed position in which the vertical face 17 of the gutter 11 clamping it between clamping member 40′ and first downwardly extending arm 22′.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

I claim:

1. A simply smart ladder clamp for gutters having a front face with a portion which has a generally vertical face with an inwardly protruding flange, said clamp comprising
a) a generally Sigma-shaped body portion having a first downwardly extending arm and a second downwardly extending arm, said first and second downwardly extending arms subtending an intermediate element having an inner laterally extending flat surface and a recess adjacent said first downwardly extending arm, said first downwardly extending arm engaging an external portion of the vertical face of the gutter and said recess accommodating the inwardly protruding flange of the gutter;
b) a clamping member having a first flat face for engaging said laterally extending surface of said body portion and a second orthogonal flat face for engaging an inner surface of the vertical face of the gutter opposite said first downwardly extending arm to clamp said simply smart ladder clamp to the vertical face of the gutter;
c) an elongated threaded member having an external thread, said elongated threaded member
i) extending through and having threaded engagement with an opening in said second downwardly extending arm; and,
ii) extending through and having non-threaded engagement with an opening in said clamping member;
d) cap means securing a first end of said elongated threaded member to said clamping member in a manner permitting rotation of said elongated threaded member in said opening in said clamping member;
e) a manually engageable element secured to a second end of said elongated threaded member;
whereby rotation of said elongated threaded member by turning said manually engageable element causes movement of said clamping member from a first non-clamping position to a second clamping position engaging the inner surface of the vertical surface of the gutter.

2. The simply smart ladder clamp of claim 1 wherein an outer portion of said subtended intermediate element is arcuate.

3. The simply smart ladder clamp of claim 1 wherein said manually engageable element comprises a five-star knurled grip thumb screw cap.

4. The simply smart ladder clamp of claim 1 wherein said manually engageable element comprises a grippable three-armed cap.

5. The simply smart ladder clamp of claim 1 wherein said cap means comprises a pair of cap rings including first auxiliary cap ring having an internal thread and its internal diameter that mates with said external thread on first end of said elongated threaded element.

6. The simply smart ladder clamp of claim 5 further comprising a second cap ring with an external thread which mates with, and is non-rotationally secured to, an internal thread in said clamping member.

7. The simply smart ladder clamp of claim 6 wherein an external diameter of said first cap ring exceeds said internal diameter of second cap ring preventing removal of said protruding end of said elongated threaded element from said clamping member.

8. The simply smart ladder clamp of claim 1 further comprising engagement means extending from a lateral surface of said sigma shaped body portion for engaging a flange on a leg of a ladder thereby preventing the ladder from lateral and outward movement.

9. The simply smart ladder clamp of claim 8 wherein said engagement means comprising a pin which is inserted into an opening in said sigma shaped body portion with a length extending laterally outwardly from a face thereof, said length forming the flange engaging element which prevents lateral and outward movement.
